(19) United States
(12) Patent Application Publication
(10) Pub. No.: US 2020/0098000 A1
(43) Pub. Date: Mar. 26, 2020

(54) APPARATUS FOR PROVIDING INFORMATION ABOUT MARKETING PERFORMANCE CONTRIBUTION AND METHOD OF ASSESSING MARKETING PERFORMANCE BY MULTI-CHANNEL ENCOUNTER

(71) Applicant: SENTIENCE INC., Seoul (KR)

(72) Inventors: Myun Soo Kim, Goyang-si (KR); Hyun Kyung LEE, Seongnam-si (KR)

(21) Appl. No.: 16/555,326

(22) Filed: Aug. 29, 2019

Related U.S. Application Data
(60) Provisional application No. 62/853,360, filed on May 28, 2019.

(30) Foreign Application Priority Data
Aug. 29, 2018 (KR) 10-2018-0102231
Aug. 1, 2019 (KR) 10-2019-0093858

(51) Int. Cl. G06Q 30/02

(52) U.S. Cl. CPC G06Q 30/0246; G06Q 30/0201

(57) ABSTRACT

In order to automatically calculate and assess a channel-specific contribution to marketing performance and provide a result of the assessment to a user, an apparatus is provided, which is for providing marketing performance contribution information, the apparatus including a server connected to a network and configured to collect channel cooperation encounter information of a customer and action information of the customer from a plurality of marketing channels, a memory storage configured to store the collected channel cooperation encounter information and action information, and a processing unit configured to calculate a channel-specific contribution on the basis of the channel cooperation encounter information and the action information, wherein the processing unit calculates the channel-specific contribution from a performance index difference due to channel cooperation when a user requests contribution information through a user terminal.

### CROSS-REFERENCE TO RELATED APPLICATION

This application claims priority to and the benefit of Korean Patent Application No. 10-2018-0102231, filed on Aug. 29, 2018, U.S. Provisional Patent Application No. 62/853,360, filed on May 28, 2019 and Korean Patent Application No. 10-2019-0093858, filed on Aug. 1, 2019, the disclosures of which are incorporated herein by references in their entireties.

### BACKGROUND

### 1. Field of the Invention

The present invention relates to an apparatus and method for automatically assessing a channel-specific contribution to marketing performance.

### 2. Discussion of Related Art

In a modern digital marketing environment in which different marketing companies contribute to one user, customers encounter an advertisement through different channels. In this case, it is essential in marketing strategy to discover to which degree the channels contributed to marketing performance.

However, conventional marketing performance assessment technologies rely on estimation methods that do not utilize economic methodology and has limitations on logical accuracy in evaluating channel-specific contributions.

### RELATED ART DOCUMENTS

### Patent Documents

<Related art document 1> Korean Patent No. 10-0492873 (registered on May 25, 2005)

<Related art document 2> Korean Patent Publication No. 10-2015-0062180 (published on Jun. 8, 2015)

### SUMMARY OF THE INVENTION

The present invention is directed to providing an apparatus for automatically calculating and assessing a channel-specific contribution to marketing performance and providing a result of the assessment to a user.

The present invention is also directed to providing a method of assessing a channel-specific contribution to marketing performance wherein the method is more reliable than a conventional assessment method.

According to an aspect of the present invention, there is provided an apparatus for providing marketing performance contribution information, the apparatus including a server connected to a network and configured to collect channel cooperation encounter information of a customer and action information of the customer from a plurality of marketing channels, a memory storage configured to store the collected channel cooperation encounter information and action information, and a processing unit configured to calculate a channel-specific contribution on the basis of the channel cooperation encounter information and the action information, wherein the processing unit calculates the channel-specific contribution from a performance index difference due to channel cooperation when a user requests contribution information through a user terminal, and the processing unit creates a contribution proportion relative to a channel-specific input cost proportion as a first graph and provides the first graph to the user terminal.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing a marketing performance contribution information provision apparatus according to an embodiment of the present invention;

FIG. 2 is a diagram showing channel encounter and action information of a customer according to an embodiment of the present invention;

FIG. 3 is a flowchart schematically illustrating a marketing performance contribution assessment method according to an embodiment of the present invention;

FIG. 4 is a flowchart showing an operation of quantifying the action information and determining the quantified action information as a performance index according to an embodiment of the present invention;

FIG. 5 is a table showing an example of a first table according to an embodiment of the present invention;

FIG. 6 is a table showing an example of a second table according to an embodiment of the present invention;

FIG. 7 shows an example of a first graph according to an embodiment of the present invention;

FIG. 8 shows an example of an encountered-channel path graph according to an embodiment of the present invention;

FIG. 9 shows an example of a marginal effect graph according to an embodiment of the present invention;

FIG. 10 is a flowchart showing an operation of calculating a channel cooperation-specific interference effect according to an embodiment of the present invention;

FIG. 11 shows an example of an interference effect graph according to an embodiment of the present invention; and

FIG. 12 shows an example of a marginal effect graph corresponding to a competitor effect according to an embodiment of the present invention.

### DETAILED DESCRIPTION OF EXEMPLARY EMBODIMENTS

The terms used herein will be described briefly, and embodiments of the present invention will be described in detail.

The terms used herein have been selected as general terms which are widely used at present in consideration of the functions of the present invention, and this may be altered according to the intent of an operator skilled in the art, conventional practice, or introduction of new technology. In addition, specific terms have been arbitrarily selected by the applicant and their meanings are explained in detail in the following description as needed. Accordingly, the terms used herein should be defined on the basis of the meaning of the terms and the content of the present invention, instead of the names of the terms.

The term “user” as used herein means a person who conducts marketing and needs analysis of marketing performance. The term “customer” means a person who encounters a channel among target consumers for marketing practiced by the user. The term “channel” means an advertising means for intermediating between a user and an advertising medium. The term “input cost” means a channel-specific cost paid by the user to practice marketing.

Hereinafter, embodiments of the present invention will be described in detail with reference to the accompanying drawings.

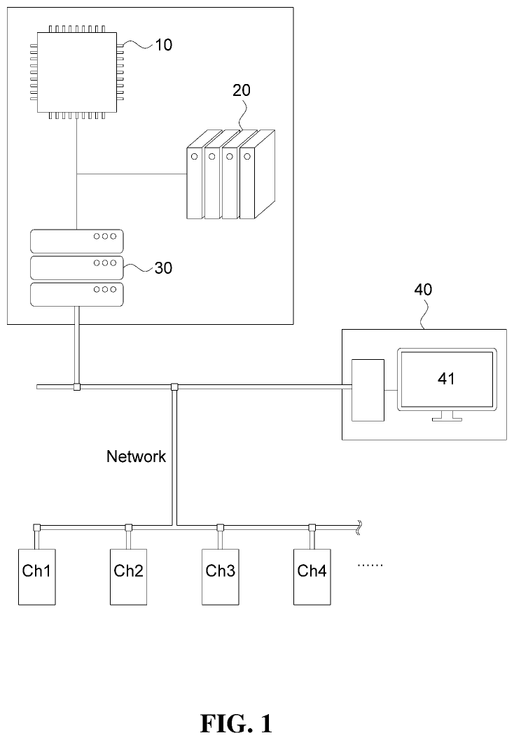

FIG. 1 is a diagram showing a marketing performance contribution information provision apparatus according to an embodiment of the present invention.

According to an embodiment, the marketing performance contribution information provision apparatus includes a processing unit 10, a memory storage 20, and a server 30. The marketing performance contribution information provision apparatus is connected to a network through the server 30 and configured to receive customer encounter information and customer action information from a plurality of marketing channels Ch through the network.

The processing unit 10 is configured to calculate a channel-specific marketing performance contribution. In detail, the processing unit 10 calculates a channel-specific marketing performance contribution on the basis of a channel encountered by a customer and the customer action information. The calculation method will be described below in detail. The processing unit 10 may be a single computer or a distributed computing system.

The memory storage 20 is configured to store channel encounter information and action information of a customer. The memory storage 20 is connected to the processing unit 10, and the processing unit 10 receives the channel encounter information and the action information stored in the memory storage 20 and calculates a channel-specific marketing performance contribution. Also, the memory storage 20 is connected to the server 30 and configured to receive the channel encounter information and the action information of the customer.

The server 30 is connected to the network and configured to collect the channel encounter information and the action information of the customer from a plurality of marketing channels Ch. Also, the server 30 is connected to the memory storage 20 and configured to deliver the collected channel encounter information and action information to the memory storage 20.

A user terminal 40 may be further included. The user terminal 40 is configured to receive an assessment result for the channel-specific marketing performance contribution provided by the server and show the assessment result to the user. To this end, the user terminal 40 includes a reception unit and a screen unit 41. The user terminal 40 may be directly connected to and included in the apparatus according to the present invention or may be connected to the server through a network. When the user terminal 40 is connected to the server 30 through the network, the server 30 provides the evaluation result for the channel-specific marketing performance contribution to the user terminal 40 through the network.

In addition, the above-described marketing performance contribution information provision apparatus may have an input unit (not shown) for receiving various user inputs.

As an embodiment, the input unit may be provided in the server 30 or the processing unit 10.

As another embodiment, the input unit may correspond to an input device installed in the user terminal 40.

In detail, the input unit may receive a user input for setting or changing a performance index criterion from the user.

Also, the input unit may receive information regarding a channel-specific input cost.

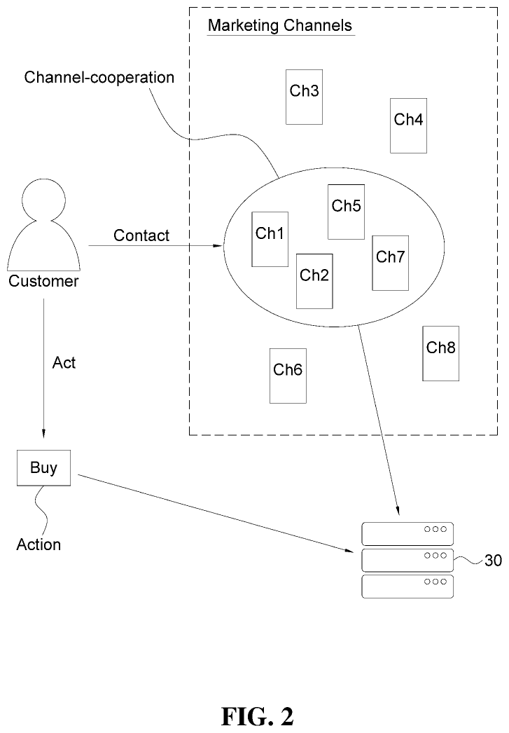

FIG. 2 is a diagram showing channel encounter and action information of a customer according to an embodiment of the present invention.

A plurality of marketing channels are provided depending on a user marketing environment. One customer encounters one or more channels from among the plurality of marketing channels and takes an action. In this case, at least one channel encountered by the customer is determined as contributing to the customer's action.

However, when the customer encounters a plurality of channels, the channels contribute differently from the case where the channels contribute independently due to mutual influence, and thus the contribution may be amplified or reduced.

Accordingly, it is not possible to discover an actual contribution when a channel contribution is solely calculated according to the conventional channel-specific contribution assessment method for marketing performance. To solve this problem, according to the present invention, a group of one or more channels encountered by a customer is defined as “channel cooperation,” and a channel-specific marketing performance contribution is calculated in consideration of a contribution due to the channel cooperation.

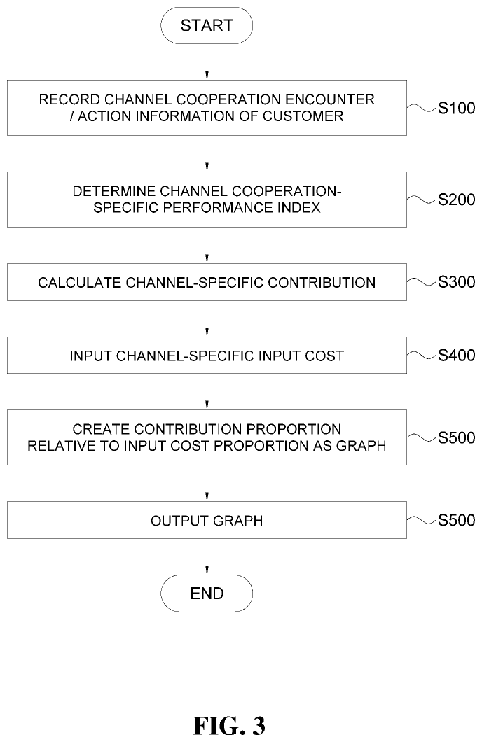

FIG. 3 is a flowchart schematically illustrating a marketing performance contribution assessment method according to an embodiment of the present invention.

The marketing performance contribution assessment method according to an embodiment of the present invention includes an operation of the server 30 recording channel cooperation encounter information and action information of a customer in the memory storage 20 (S100), an operation of the processing unit 10 quantifying the action information according to a performance index setting criterion and determining the quantified action information as a performance index (S200), an operation of the processing unit 10 calculating a channel-specific contribution on the basis of a performance index difference corresponding to channel cooperation (S300), an operation of the server 30 receiving a marketing channel-specific input cost from a user (S400), an operation of the processing unit 10 creating a contribution proportion relative to an input cost proportion in a first graph (S500), and an operation of the user terminal 40 outputting the first graph to the screen unit 41 (S600).

That is, the server 30 according to the present invention may be connected to a plurality of channels for providing marketing information over a network and may be configured to collect information regarding an action of a customer who uses a corresponding channel from the corresponding channel and information regarding channel cooperation including at least one of the plurality of channels.

In addition, the processing unit 10 may calculate a contribution for each of the plurality of channels on the basis of the information collected by the server and the predetermined performance index criterion.

In detail, the processing unit 10 may perform a comparison of the channel-specific input cost and the calculated contribution and may control the user terminal 40 such that a graph including the comparison result and relevant information is output to the user terminal 40.

The operation of the server 30 recording channel cooperation encounter information and action information of a customer in the memory storage 20 (S100) is an operation of receiving and storing information regarding a channel cooperation encountered by each customer and an action taken by the corresponding customer with respect to a total of marketing channels preset by the user. In detail, the server 30 is connected to the channels over a network, and each channel transmits encounter information whenever each customer encounters the corresponding channel. In this case, a unique identification ID is assigned to each of the customers, and thus it is possible to identify whether the same customer encounters the plurality of channels. The server 30 determines at least one channel encountered by each customer as channel cooperation of the corresponding customer on the basis of information received from the channels. Also, the server 30 receives the action information of the customer and records the channel cooperation information and the action information in the memory storage 20. As an example embodiment, a product provision connected to the server 30 over a network and configured to provide a product to a customer and automatically generate action information of the customer may be provided. The product provision unit identifies each customer using an identification ID of the corresponding customer used for marketing channels and transmits action information of the corresponding customer to the server 30. Accordingly, the server 30 may automatically record channel cooperations and action information of multiple customers.

The operation of the processing unit 10 quantifying the action information according to a performance index setting criterion and determining the quantified action information as a performance index (S200) indicates converting the action information into a numerical value for marketing performance. In detail, the type of action information includes a purchase of a product provided by a user, an installation of software provided by a user, an access to a homepage provided by a user, a subscription to a homepage provided by the user, or the like. Accordingly, action information that is usable as a direct numerical value such as sales or profits due to the product purchase can be immediately used as a performance index, but action information that cannot be quantified such as the software installation or homage subscription cannot be represented as numerical values. Therefore, numerical analysis of marketing performance is not possible. Accordingly, it is necessary to convert the action information into numeral values to facilitate analysis of marketing performance. Accordingly, a performance index setting criterion is provided as a criterion for quantifying the action information, and the processing unit 10 quantifies the action information according to the performance index setting criterion and determines the quantified action information as a performance index. The performance index setting criterion may be input from the user, and when the input is not received, a sales amount is determined as the performance index setting criterion by default.

In order to receive the performance index setting criterion from the user in advance, the method may further include an operation of the server 30 receiving the performance index setting criterion before the operation of the server 30 recording the channel cooperation encounter information and action information of a customer in the memory storage 20 (S100). The operation of the processing unit 10 calculating a channel-specific contribution on the basis of a performance index difference corresponding to channel cooperation (S300) indicates an operation of calculating the channel-specific contribution on the basis of a performance index difference between channel cooperations depending on whether a target channel on which contribution calculation is to be performed is included. In detail, the operation of calculating a channel-specific contribution (S300) includes determining differences between a performance index of each channel cooperation including a target channel on which contribution calculation is to be performed and performance indices of channel cooperations including no target channel as first calculated values, determining products of the probability of occurrence of the corresponding channel cooperation and the first calculated values as second calculated values, and determining a value obtained by adding the second calculated values as a contribution of the target channel. This can be expressed by the following Equation:

$${sh}_{i} ( N , v ) = \sum \frac{1}{N} \cdot \frac{1}{C ( K )} [ v ( K ) - v ( K / i ) ] \vert , \qquad [ Equation 1 ]$$

where N indicates the total number of channels, K indicates channel cooperation including a target channel, K/i indicates channel cooperation including no target channel, V_{( )} indicates a performance index setting criterion for the corresponding channel cooperation, and C(K) is the number of cases for the channel cooperation.

As described above, by adding up values of multiplying the probability of each channel cooperation including the target channel by contribution differences between the corresponding channel cooperation and the channel cooperations including no target channel, it is possible to accurately calculate the degree of contribution of the target channel in consideration of interactions between the channels, and thus it is possible to obtain a more substantial result compared to a conventional marketing performance calculation method which does not consider channel cooperations.

That is, for each of at least one channel cooperation including at least one target channel on which contribution calculation is to be performed among the plurality of channels, the processing unit 10 may calculate a difference between a performance index of one channel cooperation, which includes the target channel, and a performance index of another channel cooperation, which does not include the target channel, as a first calculated value.

Also, the processing unit 10 may calculate a product of the first calculated value and the probability of occurrence of the one channel cooperation as a second calculated value and add second calculated values obtained for the at least one channel cooperation to determine a contribution of the target channel.

The operation of the server 30 receiving a marketing channel-specific input cost from a user (S400) indicates receiving the channel-specific input cost as a comparison value for a channel-specific contribution proportion. The contribution information for marketing performance may be sufficient for being used to determine a contribution of each channel. However, when a channel-specific input cost is not considered, the contribution information for marketing performance may be insufficient. That is, when a channel has a low contribution proportion with respect to the entire performance but has a lower input cost proportion, the contribution of the corresponding channel should be assessed to be high. On the contrary, when a channel has a high contribution proportion with respect to the entire performance but has a higher input cost proportion, the contribution of the corresponding channel should be assessed to be low. Accordingly, the assessment of a channel-specific contribution relative to a channel-specific input cost proportion is important.

The user may input a channel-specific input cost through the user terminal 40, and the server 30 receives information regarding the channel-specific input cost from the user terminal 40. Also, the channel-specific input cost information may be stored in the memory storage 20 and used later.

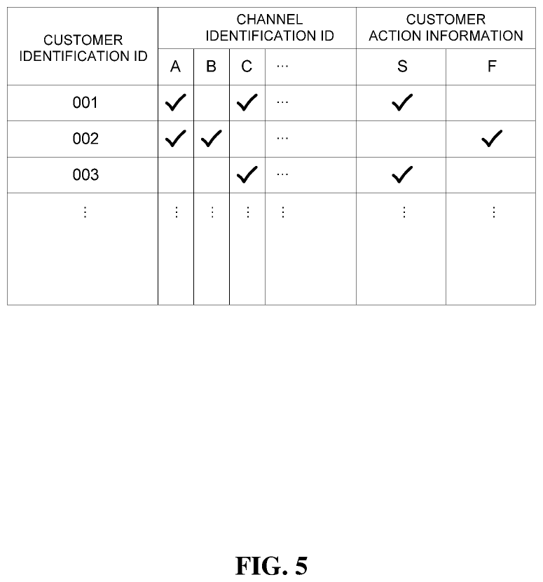

The operation of the processing unit 10 creating a contribution proportion relative to an input cost proportion in a first graph (S500) indicates creating a channel-specific input cost proportion graph and a channel-specific contribution proportion graph, comparing the difference between the two graphs, and creating the first graph. In detail, in the operation of receiving a channel-specific input cost (S400), the ratio of the input cost for each channel to the input cost for all the channels is calculated on the basis of the input cost to create the channel-specific input cost proportion graph. Also, the ratio of the contribution for each channel to the contribution for all the channels is calculated on the basis of the calculated channel-specific contribution to create the channel-specific contribution proportion graph. Also, the first graph is created by comparing the channel-specific input cost proportion graph and the channel-specific contribution proportion graph. The first graph will be described below in detail with reference to FIG. 5.

The operation of the user terminal 40 outputting the first graph to the screen unit 41 (S600) indicates providing the created first graph to the user. In detail, the processing unit 10 may provide the first graph to the user terminal 40 through the server 30, and the user terminal 40 allows the first graph to be shown to the user by outputting the first graph to the screen unit 41.

Also, depending on user settings, an operation of providing the information used and calculated in the above-described operations may be included. Here, the used information denotes the input cost, the customer channel encounter information, the customer action information, and the performance index setting criterion, and the calculated information denotes the performance index and the contribution.

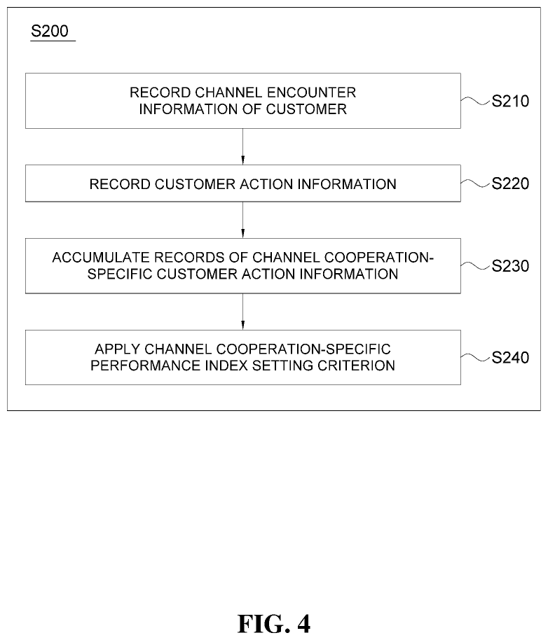

The operation of the processing unit 10 quantifying the action information according to a performance index setting criterion and determining the quantified action information as a performance index (S200) will be described below in detail with reference to FIG. 4.

FIG. 4 is a flowchart showing an operation of quantifying action information and determining the quantified action information as a performance index (S200) according to an embodiment of the present invention. The operation of quantifying action information and determining the quantified action information as a performance index (S200) includes a customer encounter information recording operation, a customer action information recording operation, a channel cooperation-specific customer action information recording and adding operation, and a channel cooperation-specific performance index setting criterion applying operation.

The customer encounter information recording operation is an operation in which a first table including a customer identification ID of a customer who encounters a channel, a channel identification ID, and an encounter time is recorded. Since one customer may encounter a plurality of channels, it is possible to identify the same customer who has encountered the plurality of channels by recording the customer identification ID.

The customer action information recording operation is an operation in which customer action information of a customer who has encountered the channel is further recorded in the first table according to the customer action information.

FIG. 5 is a table showing an example of the first table according to an embodiment of the present invention. The format and content shown in FIG. 5 are represented as an example and may vary depending on a user input, a marketing environment, and a marketing implementation situation when the present invention is actually carried out. In this embodiment, the customer action information will be described as indicating a success (S) when a customer purchases a product and a failure (F) when a customer does not purchase a product.

The channel cooperation-specific customer action information recording and adding operation is an operation in which a second table is created by accumulating channel cooperation-specific customer action information from the first table. In detail, identification IDs of the encountered channels with respect to each customer identification ID are read, and customer action information is accumulated for channel cooperation corresponding to the encountered channels and then recorded in the second table.

The channel cooperation-specific performance index setting criterion applying operation is an operation of applying the performance index setting criterion from the second table and determining the performance index.

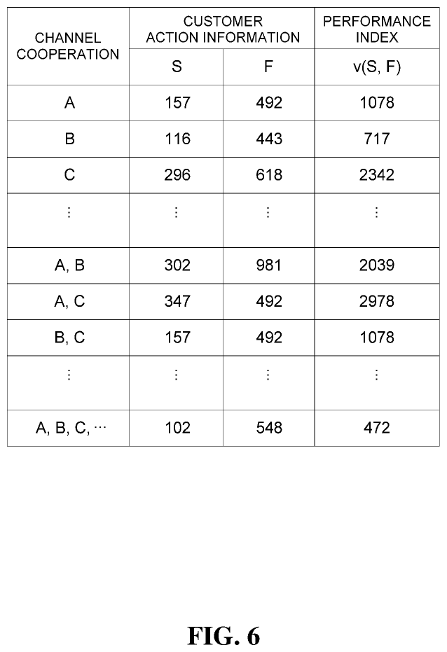

FIG. 6 is a table showing an example of the second table according to an embodiment of the present invention. The format and content shown in FIG. 6 are represented as an example and may vary depending on a user input, a marketing environment, and a marketing implementation situation when the present invention is actually carried out. In FIG. 6, the performance index setting criterion is represented with respect to an example defined as in Equation 2.

v(S,F)=10×S−F. [Equation 2]

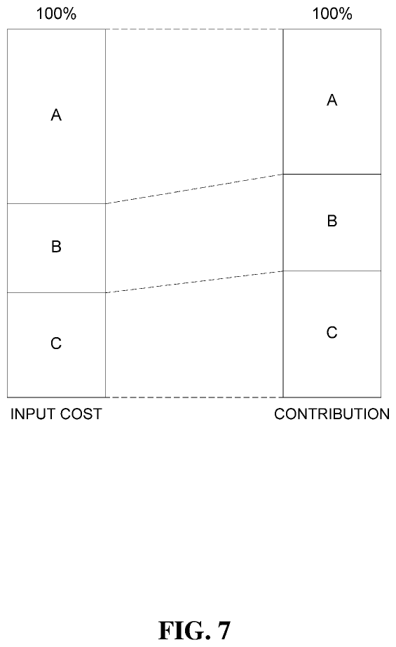

FIG. 7 shows an example of the first graph according to an embodiment of the present invention. The format and content shown in FIG. 7 are represented as an example on the assumption of three channels A, B, and C and may vary depending on a user input, a marketing environment, and a marketing implementation situation when the present invention is actually carried out.

The first graph includes a channel-specific input cost proportion graph, a channel-specific contribution proportion graph, comparison information, and text information indicating items and numerical values of each graph. By comparing the channel-specific input cost proportion and the calculated contribution proportion, visualizing the comparison result using the first graph, and providing the first graph to a user, the user may assess a contribution for each marketing channel.

The channel-specific input cost proportion graph and the channel-specific contribution proportion graph may be represented in similar formats in order to facilitate the user in perceiving the graphs. In addition, it is preferable that the same channels shown in each graph are represented in the same pattern. The pattern includes a line indicating the graph, text indicating the content of the graph, a highlighting effect to make the graph easy to perceive, and text and color for classifying the content of the graph.

The comparison information is configured to visualize the difference between the channel-specific input cost proportion graph and the channel-specific contribution proportion graph. The comparison information may include line and difference number information that makes it easier to perceive the same channel.

Meanwhile, the order in which the customer encounters channels consisting of channel cooperation may affect the contribution. In order to consider this, the channel cooperation corresponding to the order may be classified.

That is, the server 30 may identify channel cooperations in the order in which the customer encounters the plurality of channels while collecting at least one of information associated with the customer's action and information associated with the channel cooperation.

In this case, the operation of the server 30 recording channel cooperation encounter information and action information of a customer in the memory storage 20 (S100) is based on the channel cooperation classified in the order in which the customer encounters the channels, and the operation of calculating a channel-specific contribution may include calculating a channel-specific contribution on the basis of the number of cases for the channel cooperation identified in the order in which the customer encounters the channels. In this case, the permutation calculation method rather than the combination calculation method is applied to C(K) in Equation 1.

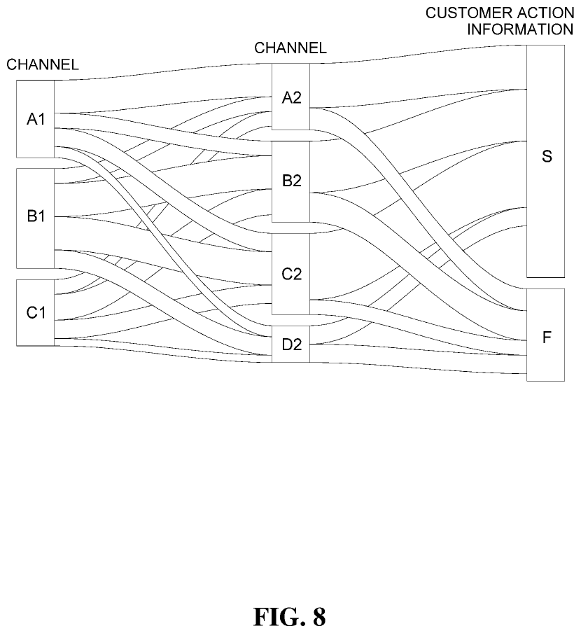

Also, after the operation of quantifying action information and determining the quantified action information as a performance index (S200), an operation of providing an encountered-channel path graph may be further included. FIG. 8 shows an example of an encountered-channel path graph according to an embodiment of the present invention. The format and content shown in FIG. 8 are represented as an example and may vary depending on a user input, a marketing environment, and a marketing implementation situation when the present invention is actually carried out. The encountered-channel path graph shows each channel as a figure with a size corresponding to a channel-specific encounter proportion and also shows a customer movement proportion with a line of a thickness corresponding to the customer movement proportion in the order in which the corresponding customer encounters the channels. Also, the encountered-channel path graph shows a customer action information proportion using a figure with a size corresponding to the customer action information proportion. By providing the encountered-channel path graph, the user can discover the correlation between the customer action information and channel encounter patterns of customers.

After the operation of calculating the channel-specific contribution (S300), an operation of calculating a channel-specific marginal effect may be included. The marginal effect refers to a phenomenon in which a contribution is linear with an input cost in one channel. The operation of calculating the marginal effect includes an operation of creating a trend line for a change in contribution according to the channel-specific input cost, an operation of calculating an estimated contribution relative to a channel-specific virtual input cost proportion through the trend line for each channel, and an operation of creating the estimated contribution relative to the channel-specific virtual input cost proportion as a marginal effect graph and providing the created marginal effect graph to the user.

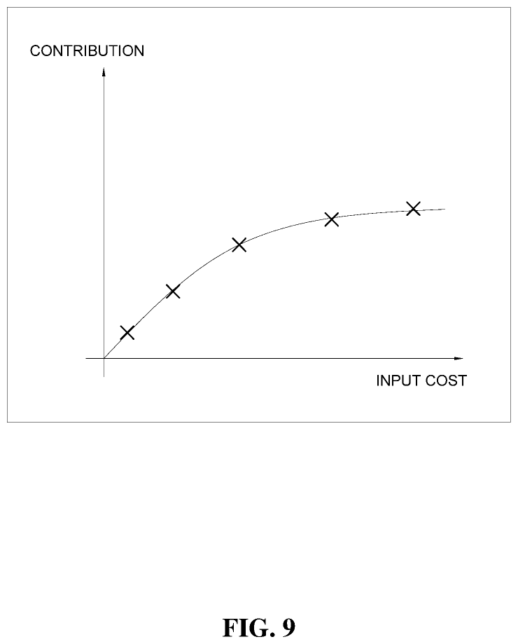

FIG. 9 shows an example of the marginal effect graph according to an embodiment of the present invention. The format and content shown in FIG. 9 are represented as an example and may vary depending on a user input, a marketing environment, and a marketing implementation situation when the present invention is actually carried out. A symbol “X” shown in FIG. 9 indicates a contribution relative to an input cost calculated through the recording, and a curved line shown in FIG. 9 indicates a trend line for a change in contribution. By providing the marginal effect graph, the user can find an input cost point indicating the maximal contribution relative to the input cost.

That is, the processing unit 10 may calculate a channel-specific contribution and then determine a trend line for a change in contribution according to the channel-specific input cost. Also, the processing unit 10 may calculate the estimated contribution relative to the channel-specific virtual input cost proportion through the trend line for each channel and then may control the user terminal such that information regarding the calculated estimated contribution is included in the graph.

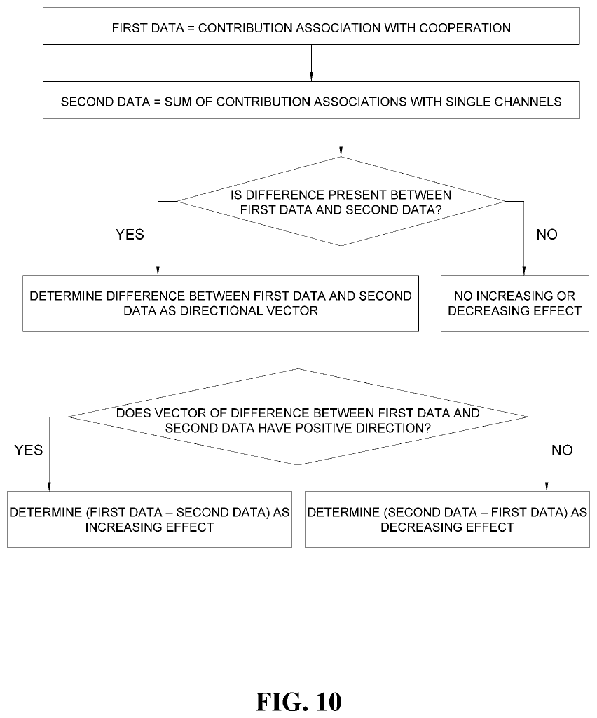

Also, after the operation of quantifying action information and determining the quantified action information as a performance index (S200), an operation of calculating a channel cooperation-specific interference effect may be included. FIG. 10 is a flowchart showing an operation of calculating a channel cooperation-specific interference effect according to an embodiment of the present invention. The operation of calculating the channel cooperation-specific interference effect includes determining a contribution association with cooperation of two or more different channels as first data, determining a sum of contribution associations achieved by the two or more different channels as second data, determining a difference between the first data and the second data as a directional vector, determining the channel cooperation as an increasing action when the vector is positive and determining the channel cooperation as a decreasing action when the vector is negative, and providing the user with a list of channel cooperations representing the increasing action or the decreasing action and the proportion of the vector.

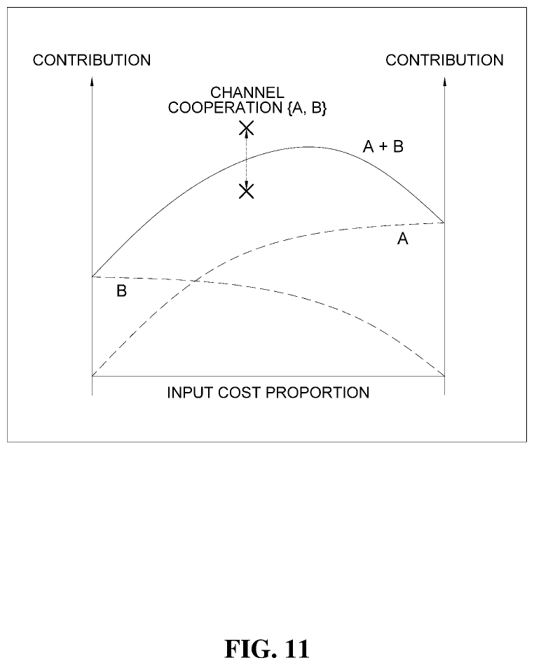

FIG. 11 shows an example of an interference effect graph according to an embodiment of the present invention. The format and content shown in FIG. 11 are represented as an example and may vary depending on a user input, a marketing environment, and a marketing implementation situation when the present invention is actually carried out. FIG. 11 shows an interference effect on the assumption of channels A and B. A dotted curved line shown in FIG. 11 indicates a marginal effect corresponding to the proportion of a channel-specific input cost. A solid curved line shown in FIG. 11 indicates a marginal effect corresponding to the proportion of a channel-specific input cost. A symbol “X” shown in FIG. 11 indicates a case in which the sum of contributions of the channels to the cooperation of A and B corresponds to the increasing effect and a case in which the sum corresponds to the decreasing effect. When the cooperation of A and B indicates the increasing effect, the symbol “X” may be displayed at an upper portion of the graph with respect to the sum of the marginal effects of the channels. On the other hand, when the cooperation of A and B indicates the decreasing effect, the symbol “X” may be displayed at a lower portion in the graph with respect to the sum of the marginal effects of the channels.

Also, an optimal cost may be calculated using the interference effect and provided to the user. The optimal cost refers to a channel-specific input cost that is recommended to be adjusted based on contribution assessment. After the operation of calculating the interference effect, an operation of providing the optimal cost using the interference effect is included. The operation of providing the optimal cost using the interference effect includes an operation of increasing the input cost by the proportion of the increasing action for a channel included in a cooperation corresponding to the increasing action to determine the increased cost input cost as an adjusted cost, an operation of decreasing the input cost by the proportion of the decreasing action for a channel included in a cooperation corresponding to the decreasing action to determine the decreased cost input as an adjusted cost, an operation of calculating an optimal cost by applying the adjusted cost for each channel in an overlapping manner, and an operation of providing the optimal cost for each channel to the user.

Meanwhile, competitor marketing may affect user marketing. The competitor refers to any other company or person who sells a product the user is selling and products of the same classification code. In order to consider this, after the operation of calculating the channel-specific contribution (S300), an operation of calculating a competitor impact effect may be included. The operation of calculating a competitor impact effect includes calculating a contribution for each channel according to the presence or absence of competitor marketing, creating a trend line for a change in contribution according to a channel-specific input cost according to the presence or absence of competitor marketing, calculating an estimated contribution relative to a channel-specific virtual input cost proportion through the trend line for each channel according to the presence or absence of marketing by the competitor, and creating the estimated contribution relative to the channel-specific virtual input cost proportion as a marginal effect graph corresponding to the competitor marketing according to the presence or absence of competitor marketing and providing the marginal effect graph to the user.

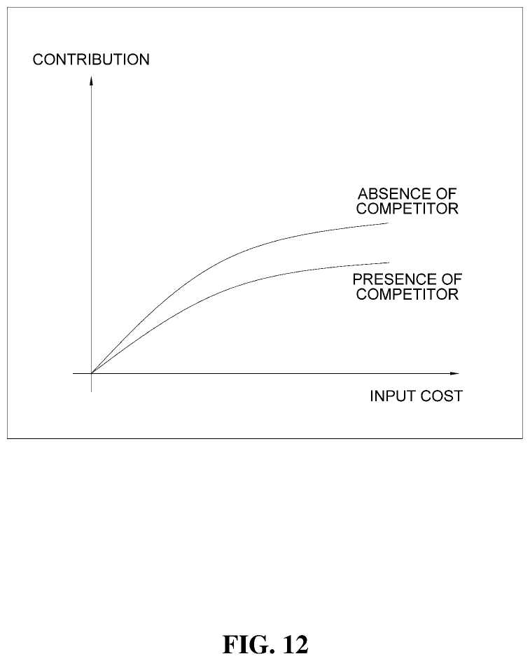

FIG. 12 shows an example of the marginal effect graph corresponding to the competitor effect according to an embodiment of the present invention. The format and content shown in FIG. 12 are represented as an example and may vary depending on a user input, a marketing environment, and a marketing implementation situation when the present invention is actually carried out. By providing the marginal effect graph corresponding to the competitor effect, the marginal effect graph may be referred to by the user in establishing a marketing strategy for each channel.

According to the present invention, it is possible to logically and accurately assess a channel-specific contribution to marketing performance and provide a result of the assessment to a user.

Also, according to the present invention, it is possible to automatically provide a channel-specific contribution to marketing performance to a user.

Also, according to the present invention, it is possible to automatically establish a new marketing strategy and provide the established marketing strategy.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An apparatus for providing marketing performance contribution information, the apparatus comprising:
a server (30) connected to a plurality of channels for providing marketing information over a network and configured to collect, from each of the channels, information regarding an action of a customer who uses the corresponding channel and information regarding a channel cooperation including at least one of the plurality of channels;
a processing unit (10) configured to calculate a contribution for each of the plurality of channels on the basis of the information collected by the server and a predetermined performance index criterion; and
a user terminal (40) configured to output information regarding the contribution,
wherein the processing unit (10) compares a channel-specific input cost and the calculated contribution and controls the user terminal (40) such that a graph including information regarding a result of the comparison is output to the user terminal (40).

2. The apparatus of claim 1, wherein the processing unit (10) calculates differences between performance indices of channel cooperations including at least one target channel, which is a target channel on which contribution calculation is to be performed among the plurality of channels, and performance indices of channel cooperations including no target channel as first calculated values, calculates products of the first calculated values and probabilities of occurrence of the channel cooperations including the target channel as second calculated values, and adds up the second calculated values to determine a value obtained through the addition as a contribution of the target channel.

3. The apparatus of claim 1, further including an input unit configured to receive a user input for setting or changing the performance index criterion from a user,
wherein when a separate user input is not applied to the input unit, the processing unit sets the performance index criterion on the basis of a sales amount corresponding to marketing information.

4. The apparatus of claim 1, wherein the server identifies the channel cooperation in an order in which the customer encounters the plurality of channels while collecting at least one of information associated with the customer's action and information associated with the channel cooperation.

5. The apparatus of claim 4, wherein the processing unit calculates the channel-specific contribution on the basis of the number of cases for the channel cooperation identified in the order in which the customer encounters the plurality of channels.

6. The apparatus of claim 5, wherein the processing unit controls the user terminal such that a graph including information associated with at least one of a channel-specific encounter proportion of the customer, a channel movement of the customer, and an action of the customer is output.

7. The apparatus of claim 1, further comprising an input unit configured to receive information regarding a channel-specific input cost from a user,
wherein after calculating the channel-specific contribution, the processing unit determines a trend line for a change in contribution according to the channel-specific input cost, calculates an estimated contribution relative to a channel-specific virtual input cost proportion through the trend line for each channel, and controls the user terminal (40) such that information regarding the calculated estimated contribution is included in the graph.

8. The apparatus of claim 1, wherein the processing unit determines a contribution association with cooperation of two or more different channels as first data, determines a sum of contribution associations achieved by the two or more different channels as second data, determines a difference between the first data and the second data as a directional vector, determines the channel cooperation as an increasing action when the vector is positive and determines the channel cooperation as a decreasing action when the vector is negative, and controls the user terminal (40) such that a list of channel cooperations representing the increasing action or the decreasing action and information regarding a proportion of the vector are output.
